(19) United States
(12) Patent Application Publication
(10) Pub. No.: US 2026/0040111 A1
(43) Pub. Date: Feb. 5, 2026

(54) TRANSMISSION AND MEASUREMENT CONCURRENCY AVOIDANCE BASED ON SYSTEM DETERMINISTIC BEHAVIOR

(71) Applicant: Apple Inc., Cupertino, CA (US)

(72) Inventors: Pratik CHANDAK, Dublin, CA (US); Mohit VAJPEYEE, Bangalore (IN); Vinay Rajkumar PATIL, San Jose, CA (US); Vijay VENKATARAMAN, San Jose, CA (US); Amit DUBEY, San Diego, CA (US)

(21) Appl. No.: 18/792,462

(22) Filed: Aug. 1, 2024

(51) Int. Cl. H04W 24/10; H04B 17/309; H04W 74/0833

(52) U.S. Cl. CPC H04W 24/10; H04B 17/346; H04W 74/0833

(57) ABSTRACT

Described herein are solutions for avoiding concurrency of scheduling request (SR)/random access channel (RACH) and measurement gaps based on system deterministic behavior. A system and decision engine can balance and adapt SR/RACH and measurement gaps. This can prioritizing SR/RACH in some scenarios and measurement gaps in other scenarios. Algorithms are provided for how, and to what extent, SR/RACH is to be favored over measurement gaps, and how, and to what extent, measurement gaps are to be favored over SR/RACH. The system and decision engine can also provide for balancing (or favoring equally) SR/RACH and measurement gaps.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks can be developed to implement fifth generation (5G) or new radio (NR) technology, sixth generation (6G) technology, and so on. Such technology can include solutions for enabling user equipment (UE) and network devices, such as base stations, to communicate with one another. A feature of such networks and devices can include coordinating and scheduling transmissions between devices.

### BRIEF DESCRIPTION OF THE DRAWINGS

The present disclosure will be readily understood and enabled by the detailed description and accompanying figures of the drawings. Like reference numerals can designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and can mean at least one, one or more, etc.

FIG. 1 is a diagram of an example overview of one or more of the techniques described herein.

FIG. 2 is a diagram of an example network according to one or more implementations described herein.

FIG. 3 is a diagram of an example of a process for transmission and measurement concurrency avoidance according to one or more implementations described herein.

FIG. 4 is a diagram of an example of a process for determining an avoidance algorithm for scheduling request (SR)/random access channel procedure (RACH) and measurement concurrency avoidance according to one or more implementations described herein.

FIG. 5 is a diagram of an example of a process for an SR/RACH favored algorithm for concurrency avoidance according to one or more implementations described herein.

FIG. 6 is a diagram of an example of a process for a measurement favored algorithm for concurrency avoidance according to one or more implementations described herein.

FIG. 7 is a diagram of an example of a process for an equally favored algorithm for concurrency avoidance according to one or more implementations described herein.

FIG. 8 is a diagram of an example of components of a device according to one or more implementations described herein.

FIG. 9 is a diagram of example interfaces of baseband circuitry according to one or more implementations described herein.

FIG. 10 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 11 is a diagram of an example process for SR/RACH and measurement concurrency avoidance according to one or more implementations described herein.

### DETAILED DESCRIPTION

The following detailed description refers to the accompanying drawings. Like reference numbers in different drawings can identify the same or similar features, elements, operations, etc. Additionally, the present disclosure is not limited to the following description as other implementations can be utilized, and structural or logical changes made, without departing from the scope of the present disclosure.

Wireless communication networks can include user equipment (UE) capable of communicating with base stations and/or other network access nodes. The base stations can provide A UE with access to a core network (CN) and additional external networks, such as the Internet. Wireless communication networks can implement various techniques and standards that enable services to be provided to UEs in a consistent and high-quality manner. An aspect of providing reliable and quality wireless services includes coordinating and scheduling transmissions between devices.

A random access channel (RACH) procedure can be performed by a UE to get uplink (UL) synchronization with a base station and to request time and frequence resources for sending information to the base station. The request for resource can include a scheduling request. There are currently two types of random access procedures, contention based random access (CBRA) and contention free random access (CFRA). Briefly, CBRA enables the UE to select a random access preamble form a pool of preambles shared with other UEs. This means that the UE risks selecting the same preamble as another UE, creating contention for access between the UEs. By contrast, CFRA involves the base station allocating a dedicated random access preamble to a UE, thereby removing the possibility of the UE experiencing contention with another UE.

A UE can use a scheduling request (SR) procedure to request air-interface resources for a new UL transmission. For an SR procedure, UL data belonging to a specific logical channel is queued for transmission within a UE buffer. The uplink data triggers the UE to send a scheduling request using physical UL control channel (PUCCH) resources that have been configured specifically for the logical channel that has the UL data ready for transmission. The base station receives the scheduling request and can deduce the logical channel (or group of logical channels when multiple logical channels have been linked to the same set of PUCCH resources). Awareness of the logical channel can help the base station prioritize the scheduling request. A UE is not free to transmit a scheduling request at any time. Instead, the base station provides the UE with timing information indicating when a UE is permitted to transmit a Scheduling request. This timing information includes the SR-periodicity and SR-offset. When a UE does not have a PUCCH for transmitting a scheduling request, the UE can be required to first complete a RACH procedure. Scheduling requests can further be limited by a prohibition timer, a scheduling request counter and maximum, and more.

Measurement gaps can be used when a UE is to perform measurements that cannot be completed while the UE is tuned to the current serving cell. Measurement gaps can impact performance because measurement gaps can interrupt both UL and downlink (DL) data transfer. This means that measurement gaps should be configured sparingly. In long-term evolution (LTE) networks, Measurement gaps are typically configured for inter-frequency and inter-system measurements. The measurement gaps provide sufficient time for the UE to re-tune its transceiver to the target carrier, complete the set of measurements and then re-tune its transceiver back to the original carrier. It is common to assume that each re-tuning operation requires up to 0.5 milliseconds (ms). In new radio (NR) networks, Measurement gaps can be required for intra-frequency measurements, in addition to inter-frequency and inter-system measurements. For example within Frequency Range (FR) 2, a UE uses analogue receiver beamforming. The UE beam is normally directed toward the serving cell, whereas neighbor cell measurements will involve the beam to be directed towards the neighboring cells. Measurement gaps are used while the UE redirects its beam and temporarily stops transmitting and receiving with the serving cell. Also, the UE can be configured with an active bandwidth part (BWP) that does not contain an intra-frequency synchronization signal (SS)/physical broadcast channel (PBCH) block. Instead, the UE re-tunes its transceiver to receive the intra-frequency SS/PBCH block. This scenario is similar to re-tuning for inter-frequency measurements.

Currently, a SR/RACH occasion can overlap with a measurement gap. SR/RACH, as used herein, can refer to an SR, RACH request, SR procedure, RACH procedure, SR occasion, RACH occasion, and/or any combination thereof. For example, SR/RACH can refer only to an SR and/or a RACH request. SR/RACH can also, or alternatively, refer to an SR procedure a RACH procedure. As such, SR/RACH as used herein is to be interpreted broadly and with versatility, covering both inclusive and exclusive interpretations thereof.

Based on the measurement gap periodicity, SR periodicity and RACH occasion, SR/RACH might fall in the measurement gap. Whenever uplink synchronization is needed between a UE and a base station, a RACH procedure is performed. When the UE remains attached to the same cell, the UE can experience SR/RACH and measurement concurrency many times, which can interrupt functionality and adversely impact the user experience. Prioritizing SR/RACH over measurement can adversely affect performance in multiple ways, such as a reduced ability of the UE to select and connect to better cells due to a lack of measurement reports. By contrast, prioritizing measurement over SR/RACH can adversely affect performance in other ways, such as reducing access to time and frequency resources required or preferred by services involving elevated data traffic. Currently available technologies provide no or inadequate solutions for avoiding conflict, concurrency, or overlap between SR/RACH and measurement gaps.

One or more of the techniques described herein address these deficiencies by providing a system and decision engine for properly balancing and adapting SR/RACH and measurement gaps. The system and decision can include a prioritization algorithm for prioritizing a transmission from a UE (e.g., a SR/RACH request) in some scenarios and measurement gaps in other scenarios. Also included are algorithms for how, and to what extent, SR/RACH is to be favored over measurement gaps, and how, and to what extent, measurement gaps are to be favored over SR/RACH. The system and decision engine can also include algorithms for balancing or favoring SR/RACH and measurement gaps equally. While techniques and examples described herein may reference an SR, a RACH request, etc., the techniques can be applied to any time of transmission from the UE. As such, references to an SR, a RACH request, etc., can include any type of transmission. Similarly, references to an SR counter, RACH counter, SR/RACH counter, etc., can include a counter of any type of transmission. These and many other features and examples are described below with reference to the Figures.

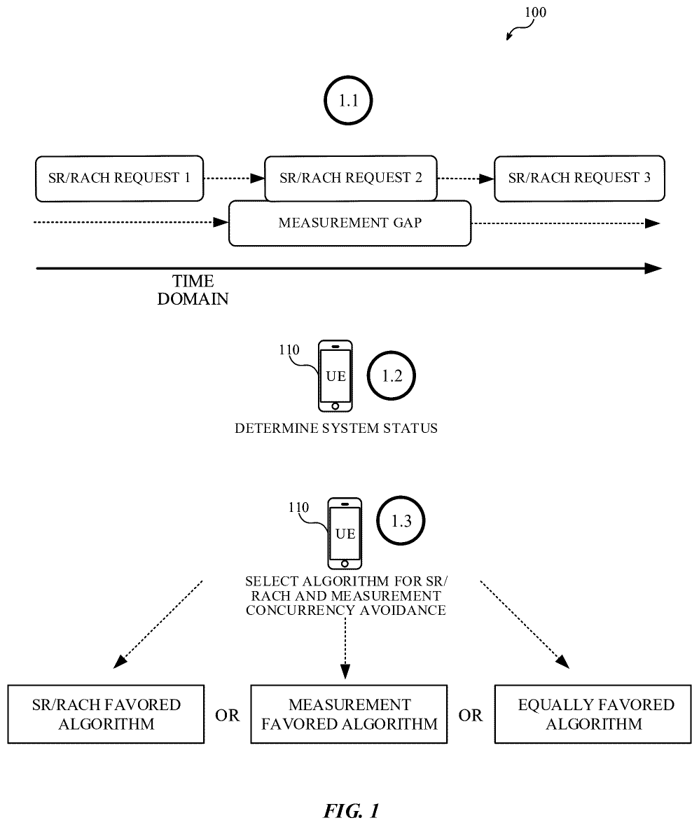

FIG. 1 is a diagram of an example overview 100 of one or more implementations described herein. As shown, overview 100 can include UE 110. UE 110 can have a sequency of resources and occasions for SR/RACH procedures and request (e.g., SR/RACH request 1, SR/RACH request 2, and SR/RACH request 3) and measurement gaps for performing measurements (at 1.1). An SR/RACH request can overlap in a time domain with a measurement gap. UE 110 can determine a system status based on system status information collected by UE 110 (at 1.2). The system status information can include measurements and information relative to an operational status and environment of UE 110. UE 110 can select an algorithm for SR/RACH and concurrency avoidance based on the system status and system status information of UE 110 (at 1.3). The algorithm can be configured to favor SR/RACH procedures over measurements, favor measurements over SR/RACH procedures, or equally favor SR/RACH and measurement procedures. As the selected algorithm is used, the algorithm is capable of adapting to ongoing conditions, such as a number of SR or RACH requests transmitted, a maximum number of SR or RACH request transmissions, and a number of measurement procedures initiated, such that even when the algorithm favors one over the other, neither is entirely ignored or disregarded. Additional examples of these and many other techniques, features, and implementations are described below with reference to the figures that follow.

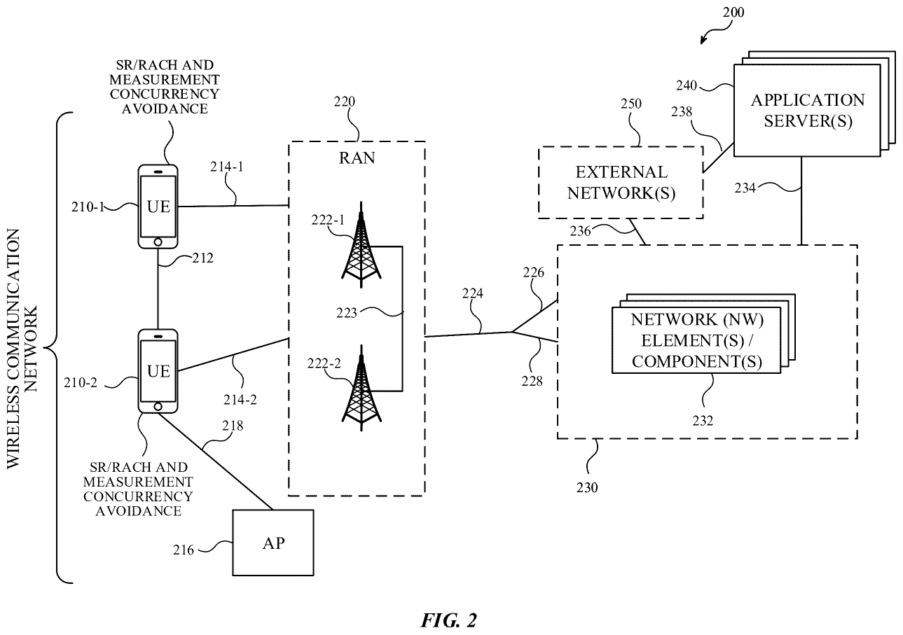

FIG. 2 is an example network 200 according to one or more implementations described herein. Example network 200 can include UEs 210, 210-2, etc. (referred to collectively as “UEs 210” and individually as “UE 210”), a radio access network (RAN) 220, a core network (CN) 230, application servers 240, and external networks 250.

The systems and devices of example network 200 can operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 200 can operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 210 can include smartphones (e.g., handheld touchscreen mobile computing devices connectable to one or more wireless communication networks). Additionally, or alternatively, UEs 210 can include other types of mobile or non-mobile computing devices capable of wireless communications, such as personal data assistants (PDAs), pagers, laptop computers, desktop computers, wireless handsets, etc. In some implementations, UEs 210 can include internet of things (IoT) devices (or IoT UEs) that can comprise a network access layer designed for low-power IoT applications utilizing short-lived UE connections. Additionally, or alternatively, an IoT UE can utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more.

Depending on the scenario, an M2M or MTC exchange of data can be a machine-initiated exchange, and an IoT network can include interconnecting IoT UEs (which can include uniquely identifiable embedded computing devices within an Internet infrastructure) with short-lived connections. In some scenarios, IoT UEs can execute background applications (e.g., keep-alive messages, status updates, etc.) to facilitate the connections of the IoT network. UEs 210 can communicate and establish a connection with one or more other UEs 210 via one or more wireless channels 212, each of which can comprise a physical communications interface/layer. The connection can include an M2M connection, MTC connection, D2D connection, SL connection, etc. The connection can involve a PC5 interface. In some implementations, UEs 210 can be configured to discover one another, negotiate wireless resources between one another, and establish connections between one another, without intervention or communications involving RAN node 222 or another type of network node. In some implementations, discovery, authentication, resource negotiation, registration, etc., can involve communications with RAN node 222 or another type of network node.

UEs 210 can use one or more wireless channels 212 to communicate with one another. As described herein, UE 210 can communicate with RAN node 222 to request SL resources. RAN node 222 can respond to the request by providing UE 210 with a dynamic grant (DG) or configured grant (CG) regarding SL resources. A DG can involve a grant based on a grant request from UE 210. A CG can involve a resource grant without a grant request and can be based on a type of service being provided (e.g., services that have strict timing or latency requirements). UE 210 can perform a clear channel assessment (CCA) procedure based on the DG or CG, select SL resources based on the CCA procedure and the DG or CG; and communicate with another UE 210 based on the SL resources. The UE 210 can communicate with RAN node 222 using a licensed frequency band and communicate with the other UE 210 using an unlicensed frequency band.

UEs 210 can communicate and establish a connection with (e.g., be communicatively coupled) with RAN 220, which can involve one or more wireless channels 214-1 and 214-2, each of which can comprise a physical communications interface/layer. In some implementations, a UE can be configured with dual connectivity (DC) as a multi-radio access technology (multi-RAT) or multi-radio dual connectivity (MR-DC), where a multiple receive and transmit (Rx/Tx) capable UE can use resources provided by different RAN network nodes (e.g., RAN network nodes 222-1 and 222-2) that can be connected via non-ideal backhaul (e.g., where one network node provides NR access and the other network node provides either E-UTRA for LTE or NR access for 5G). In such a scenario, one network node can operate as a master node (MN) and the other as the secondary node (SN). The MN and SN can be connected via a network interface, and at least the MN can be connected to the CN 230. Additionally, at least one of the MN or the SN can be operated with shared spectrum channel access, and functions specified for UE 210 can be used for an integrated access and backhaul mobile termination (IAB-MT). Similar for UE 210, the IAB-MT can access the network using either one network node or using two different nodes with enhanced dual connectivity (EN-DC) architectures, new radio dual connectivity (NR-DC) architectures, or the like. In some implementations, a base station (as described herein) can be an example of network RAN network nodes.

As shown, UE 210 can also, or alternatively, connect to access point (AP) 216 via connection interface 218, which can include an air interface enabling UE 210 to communicatively couple with AP 216. AP 216 can comprise a wireless local area network (WLAN), WLAN node, WLAN termination point, etc. The connection 216 can comprise a local wireless connection, such as a connection consistent with any IEEE 702.11 protocol, and AP 216 can comprise a wireless fidelity (Wi-Fi®) router or other AP. While not explicitly depicted in FIG. 2, AP 216 can be connected to another network (e.g., the Internet) without connecting to RAN 220 or CN 230. In some scenarios, UE 210, RAN 220, and AP 216 can be configured to utilize LTE-WLAN aggregation (LWA) techniques or LTE WLAN radio level integration with IPsec tunnel (LWIP) techniques. LWA can involve UE 210 in RRC_CONNECTED being configured by RAN 220 to utilize radio resources of LTE and WLAN. LWIP can involve UE 210 using WLAN radio resources (e.g., connection interface 218) via IPsec protocol tunneling to authenticate and encrypt packets (e.g., Internet Protocol (IP) packets) communicated via connection interface 218. IPsec tunneling can include encapsulating the entirety of original IP packets and adding a new packet header, thereby protecting the original header of the IP packets.

RAN 220 can include one or more RAN nodes 222-1 and 222-2 (referred to collectively as RAN nodes 222, and individually as RAN node 222) that enable channels 214-1 and 214-2 to be established between UEs 210 and RAN 220. RAN nodes 222 can include network access points configured to provide radio baseband functions for data and/or voice connectivity between users and the network based on one or more of the communication technologies described herein (e.g., 2G, 3G, 4G, 5G, WiFi®, etc.). As examples therefore, a RAN node can be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 222 can include a roadside unit (RSU), a transmission reception point (TRxP or TRP), and one or more other types of ground stations (e.g., terrestrial access points). In some scenarios, RAN node 222 can be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 222, or portions thereof, can be implemented as one or more software entities running on server computers as part of a virtual network, which can be referred to as a centralized RAN (CRAN) and/or a virtual baseband unit pool (vBBUP). In these implementations, the CRAN or vBBUP can implement a RAN function split, such as a packet data convergence protocol (PDCP) split wherein radio resource control (RRC) and PDCP layers can be operated by the CRAN/vBBUP and other Layer 2 (L2) protocol entities can be operated by individual RAN nodes 222; a media access control (MAC)/physical (PHY) layer split wherein RRC, PDCP, radio link control (RLC), and MAC layers can be operated by the CRAN/vBBUP and the PHY layer can be operated by individual RAN nodes 222; or a “lower PHY” split wherein RRC, PDCP, RLC, MAC layers and upper portions of the PHY layer can be operated by the CRAN/vBBUP and lower portions of the PHY layer can be operated by individual RAN nodes 222. This virtualized framework can allow freed-up processor cores of RAN nodes 222 to perform or execute other virtualized applications.

In some implementations, an individual RAN node 222 can represent individual gNB-distributed units (DUs) connected to a gNB-control unit (CU) via individual F1 or other interfaces. In such implementations, the gNB-DUs can include one or more remote radio heads or radio frequency (RF) front end modules (RFEMs), and the gNB-CU can be operated by a server (not shown) located in RAN 220 or by a server pool (e.g., a group of servers configured to share resources) in a similar manner as the CRAN/vBBUP. Additionally, or alternatively, one or more of RAN nodes 222 can be next generation eNBs (i.e., gNBs) that can provide evolved universal terrestrial radio access (E-UTRA) user plane and control plane protocol terminations toward UEs 210, and that can be connected to a 5G core network (5GC) 230 via an NG interface.

Any of the RAN nodes 222 can terminate an air interface protocol and can be the first point of contact for UEs 210. In some implementations, any of the RAN nodes 222 can fulfill various logical functions for the RAN 220 including, but not limited to, radio network controller (RNC) functions such as radio bearer management, uplink and downlink dynamic radio resource management and data packet scheduling, and mobility management. UEs 210 can be configured to communicate using orthogonal frequency-division multiplexing (OFDM) communication signals with each other or with any of the RAN nodes 222 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals can comprise a plurality of orthogonal subcarriers.

In some implementations, a downlink resource grid can be used for downlink transmissions from any of the RAN nodes 222 to UEs 210, and uplink transmissions can utilize similar techniques. The grid can be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block can comprise a collection of resource elements (REs); in the frequency domain, this can represent the smallest quantity of resources that currently can be allocated. There are several different physical downlink channels that are conveyed using such resource blocks.

Further, RAN nodes 222 can be configured to wirelessly communicate with UEs 210, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum can correspond to channels or frequency bands selected, reserved, regulated, etc., for certain types of wireless activity (e.g., wireless telecommunication network activity), whereas an unlicensed spectrum can correspond to one or more frequency bands that are not restricted for certain types of wireless activity. Whether a particular frequency band corresponds to a licensed medium or an unlicensed medium can depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 210 and the RAN nodes 222 can operate using stand-alone unlicensed operation, licensed assisted access (LAA), eLAA, and/or feLAA mechanisms. In these implementations, UEs 210 and the RAN nodes 222 can perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations can be performed according to a listen-before-talk (LBT) protocol.

The PDSCH can carry user data and higher layer signaling to UEs 210. The physical downlink control channel (PDCCH) can carry information about the transport format and resource allocations related to the PDSCH channel, among other things. The PDCCH can also inform UEs 210 about the transport format, resource allocation, and hybrid automatic repeat request (HARQ) information related to the uplink shared channel. Typically, downlink scheduling (e.g., assigning control and shared channel resource blocks to UE 210 within a cell) can be performed at any of the RAN nodes 222 based on channel quality information fed back from any of UEs 210. The downlink resource assignment information can be sent on the PDCCH used for (e.g., assigned to) each of UEs 210.

The RAN nodes 222 can be configured to communicate with one another via interface 223. In implementations where the system is an LTE system, interface 223 can be an X2 interface. In NR systems, interface 223 can be an Xn interface. The X2 interface can be defined between two or more RAN nodes 222 (e.g., two or more eNBs/gNBs or a combination thereof) that connect to evolved packet core (EPC) or CN 230, or between two eNBs connecting to an EPC. In some implementations, the X2 interface can include an X2 user plane interface (X2-U) and an X2 control plane interface (X2-C).

The X2-U can provide flow control mechanisms for user data packets transferred over the X2 interface and can be used to communicate information about the delivery of user data between eNBs or gNBs. For example, the X2-U can provide specific sequence number information for user data transferred from a master eNB (MeNB) to a secondary eNB (SeNB); information about successful in sequence delivery of PDCP packet data units (PDUs) to a UE 210 from an SeNB for user data; information of PDCP PDUs that were not delivered to a UE 210; information about a current minimum desired buffer size at the SeNB for transmitting to the UE user data; and the like. The X2-C can provide intra-LTE access mobility functionality (e.g., including context transfers from source to target eNBs, user plane transport control, etc.), load management functionality, and inter-cell interference coordination functionality.

As shown, RAN 220 can be connected (e.g., communicatively coupled) to CN 230. RAN 220 communicate with CN 230 via interfaces 224, 226, and/or 228. CN 230 can comprise a plurality of network elements 232, which are configured to offer various data and telecommunications services to customers/subscribers (e.g., users of UEs 210) who are connected to the CN 230 via the RAN 220. In some implementations, CN 230 can include an evolved packet core (EPC), a 5G CN, and/or one or more additional or alternative types of CNs. The components of the CN 230 can be implemented in one physical node, or separate physical nodes including components to read and execute instructions from a machine-readable or computer-readable medium (e.g., a non-transitory machine-readable storage medium). In some implementations, network function virtualization (NFV) can be utilized to virtualize any or all the above-described network node roles or functions via executable instructions stored in one or more computer-readable storage mediums (described in further detail below). A logical instantiation of the CN 230 can be referred to as a network slice, and a logical instantiation of a portion of the CN 230 can be referred to as a network sub-slice. Network Function Virtualization (NFV) architectures and infrastructures can be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more EPC components/functions.

As shown, CN 230, application servers 240, and external networks 250 can be connected to one another via interfaces 234, 236, and 238, which can include IP network interfaces. Application servers 240 can include one or more server devices or network elements (e.g., virtual network functions (VNFs) offering applications that use IP bearer resources with CM 230 (e.g., universal mobile telecommunications system packet services (UMTS PS) domain, LTE PS data services, etc.). Application servers 240 can also, or alternatively, be configured to support one or more communication services (e.g., voice over IP (VoIP) sessions, push-to-talk (PTT) sessions, group communication sessions, social networking services, etc.) for UEs 210 via the CN 230. Similarly, external networks 250 can include one or more of a variety of networks, including the Internet, thereby providing the mobile communication network and UEs 210 of the network access to a variety of additional services, information, interconnectivity, and other network features.

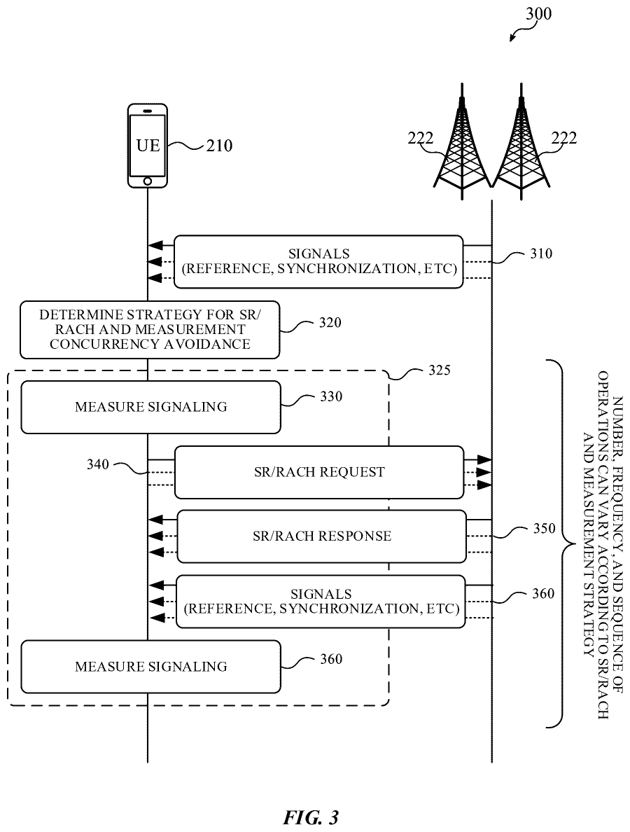

FIG. 3 is a diagram of an example of a process for transmission and measurement concurrency avoidance according to one or more implementations described herein. As shown, process 300 can be implemented by UE 210 and base station 222. In some implementations, some or all of process 300 can be performed by one or more other systems or devices, including one or more of the devices of FIG. 2. Additionally, process 300 can include one or more fewer, additional, differently ordered and/or arranged operations than those shown in FIG. 3. In some implementations, some or all of the operations of process 300 can be performed independently, successively, simultaneously, etc., of one or more of the other operations of process 300. As such, the techniques described herein are not limited to a number, sequence, arrangement, timing, etc., of the operations or processes depicted in FIG. 3.

While techniques and examples described herein may reference an SR, a RACH request, etc., the techniques can be applied to any time of transmission from the UE. As such, references to an SR, a RACH request, etc., can include any type of transmission. Similarly, references to an SR counter, RACH counter, SR/RACH counter, etc., can include a counter of any type of transmission. For example, a SR/RACH transmission maximum can be a non-limiting example of a transmission maximum, and a modified SR/RACH, and a modified SR/RACH transmission maximum can be a non-limiting example of a modified transmission maximum, and a modified SR/RACH

As shown, process 300 can include one or more base stations 222 transmitting signals to UE 210 (at 310). The signals can include reference signals, synchronization signals, and more. The signals can be transmitted via a physical broadcast channel (PBCH) and one or more other types of channels. Base stations 222 can include a serving cell and one or more neighboring cells. UE 210 can receive, decode, and/or measure the signals.

Process 300 can include UE 210 determining a strategy for SR/RACH and measurement concurrency avoidance (at 320). For example, UE 210 can collect one or more types of system status information, determine a system or operational status of UE 210, and select a strategy or algorithm to prioritize or prefer SR/RACH procedures over measurement procedures, prioritize or prefer measurement procedures over SR/RACH procedures, or to give equal priority and preference to SR/RACH procedures and measurement procedures.

Process can include UE 210 performing SR/RACH procedures and measurement procedures according to the strategy for SR/RACH and measurement concurrency avoidance (block 330). SR/RACH and measurement concurrency avoidance strategy 325 can include a combination of measurement procedures 330 and 360 for signaling (at 310 and 360) from base station 222. SR/RACH and measurement concurrency avoidance strategy 325 can also include SR/RACH requests (at 340) that can result in SR/RACH responses (at 350) from one or more base station 222. The number, frequency, and sequence of operations 330, 340, and 360 of SR/RACH and measurement concurrency avoidance strategy 325 can vary based on whether the strategy includes prioritizing SR/RACH procedures over measurement procedures, prioritizing measurement procedures over SR/RACH procedures, or giving equal priority SR/RACH and measurement procedures. Additional examples and details of SR/RACH and measurement concurrency avoidance are described below with reference to the Figures that follow.

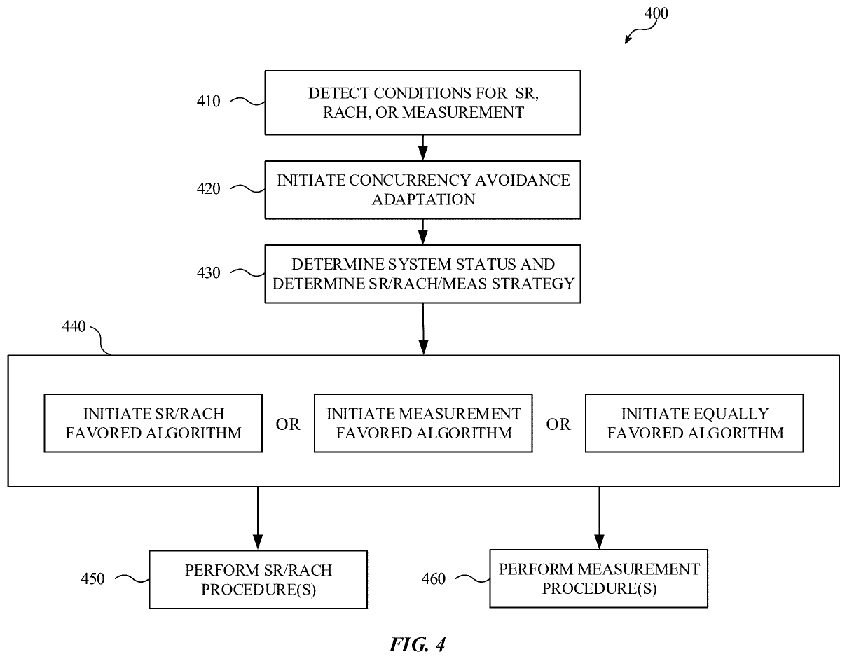

FIG. 4 is a diagram of an example of a process 400 for determining an avoidance algorithm for SR/RACH and measurement concurrency avoidance according to one or more implementations described herein. Process 400 can be implemented by UE 210 as a decision engine, comprising instructions, data structures, and other information, for SR/RACH procedures versus measurement procedures. As described below, decision engine or framework can be used to determine which type of avoidance algorithm is to be used for SR/RACH and measurement concurrency avoidance.

Process 400 can be implemented by UE 210. In some implementations, some or all of process 400 can be performed by one or more other systems or devices, including one or more of the devices of FIG. 2. Additionally, process 400 can include one or more fewer, additional, differently ordered and/or arranged operations than those shown in FIG. 4. In some implementations, some or all of the operations of process 400 can be performed independently, successively, simultaneously, etc., of one or more of the other operations of process 400. As such, the techniques described herein are not limited to a number, sequence, arrangement, timing, etc., of the operations or processes depicted in FIG. 4.

Process 400 can include detecting conditions for SR/RACH or measurement (block 410). For example, UE 210 can receive a request, and/or detect a prompt, trigger, or conditions, for scheduling time and frequency resources for communicating with base station 222. The prompt can include UE 210 an SR being generated or a request for an SR to be generated. An SR procedure can include requesting air-interface resources for a new UL transmission. For an SR procedure, UL data belonging to a specific logical channel can be queued for transmission within a UE buffer. The UL data can trigger UE 210 to send a scheduling request using PUCCH resources that have been configured specifically for the logical channel that has the UL data ready for transmission.

Additionally, or alternatively, UE 210 can receive a request, and/or detect a prompt, trigger, or conditions, to perform a RACH procedure. A RACH procedure can be performed by UE 210 to become synchronized with base station 222 and to request time and frequence resources for sending information to base station 222. The request for resource can include a SR. The RACH can be a CBRA or a CFRA. The prompt can include UE 210 generating request to initiate a RACH procedure. Additionally, or alternatively, UE can receive a request, and/or detect a prompt, trigger, or conditions, to perform measurements during a measurement gap. Measurement gaps can be used to evaluate signals, and characteristics of signals, from one or more base stations 222. The signals can be from a base station 222 serving UE 210, a neighboring base station 222, and/or one or more other types of network access devices. Examples of such signals can include synchronization signals, reference signals (RS), and more. Measuring signals during measurement gaps can enable UE 210 to determine signal strengths from different base stations 222 and determine whether to switch from one base station 222 to another base station 222.

Process 400 can include initiating concurrency avoidance adaptation (block 420). For example, UE 210 can initiate a concurrency avoidance adaptation procedure in response to detecting a trigger or conditions for SR, RACH, and/or measurement. UE 210 can collect system status information, such as a traffic type, traffic quantity, quality of service (QoS), UE mobility, power consumption, measured signal strengths, currently allocated time and frequency resources. The traffic type can include a type data corresponding to an application or service for which UE 210 is to send a SR or perform a RACH procedure. The traffic type can include an indication of an application or service designed for high-volume and low latency traffic (e.g., augmented reality applications, virtual reality applications, etc.) or other metrics indicating a quantity of data, transmission rate, latency, etc., of UL and/or DL data. UE mobility can include a current and expected velocity and/or acceleration of UE 210. Measured signal strengths can include a reference signal received power (RSRP) associated with one or more base stations. Currently allocated time and frequency resources can include UL and DL resources, channels, etc., that are currently allocated to UE 210. The QoS can include a QoS associated with an application or service for which a prompt, trigger, or conditions have been detected for an SR and/or RACH procedure.

Process 400 can include determining a system status and determine a SR/RACH/Meas strategy (block 430). For example, UE 210 can determine a system status based on system status information collected by UE 210. The term Meas can refer to measurement, measurements, etc. The system status can be determined as having one or more characteristics describing a current state of operation of UE 210. Examples of such characteristics can include high velocity, low latency, low velocity, high latency, a UE mobility, etc., or a combination thereof. Additional examples of a system status characteristics can include a measured signal strength or condition, a degree of signal interference, a number of unsuccessful SR procedures and/or RACH procedures, a signal radio bearer (SRB) measurement report, UE 210 operating in a low latency mode, a number or frequency of hybrid automatic repeat-request (HARQ) transmission or retransmissions, a power headroom report, a network initiated RACH, a timing advance (TA) between UE 210 and base station 222, and more. As an example, measurement procedure can have priority when UE mobility is high or signal interference is elevated. By contrast, SR/RACH procedure can have priority when operating in a low latency mode, in response to elevated HARQ retransmissions, etc.

UE 210 can also, or alternatively, determine an SR/RACH/Meas strategy. Determining the SR/RACH/Meas strategy can include determining, based on the system information and/or system status, whether and to what extent SR, RACH, or measurements should be prioritized relative to one another. For example, when the system status is characterized as high velocity, priority can be given to measurement procedures as UE 210 can be expected to switch base stations 222 at a greater rate than a UE 210 with a lower velocity system state. As another example, when the system state characterized as high-volume, low latency data transfers, priority can be given to SR/RACH procedures to ensure adequate wireless resources are available to UE 210.

UE 210 can determine the system status and/or SR/RACH/Meas strategy by weighing system status information with SR/RACH/Meas strategy a number or counter value corresponding to recent SR/RACH requests, a threshold number or maximum number of SR/RACH requests, a number or counter value corresponding to recent measurements, a threshold number or maximum number of measurements, etc. Determining the SR/RACH/Meas strategy can include determine, identifying, and/or selecting an algorithm germane to the system status. The SR/RACH/Meas strategy can include initiating an SR/RACH favored algorithm, an algorithm that favors SR, an algorithm that favors RACH, an algorithm that favors SR and RACH, an algorithm that favors measurements, or an algorithm that equally favors SR/RACH and measurements.

Process 400 can include initiating an SR/RACH favored algorithm, initiating a measurement favored algorithm, or initiating an equally favored algorithm (block 440). For example, UE 210 can initiate an SR/RACH favored algorithm, a measurement favored algorithm, or an equally favored algorithm. The SR/RACH favored algorithm can prioritize SR and/or RACH procedures over measurement procedures. The measurement favored algorithm can prioritize measurement procedures over SR and/or RACH procedures. The equally favored algorithm can apply an equal degree of prioritization to SR procedures, RACH procedures, and measurement procedures. An algorithm favoring SR/RACH can be selected when system status information includes a traffic type corresponding to low latency requirements and high throughput requirements. An algorithm favoring measurement can be selected when system status information includes high UE mobility and poor signaling conditions (e.g., a higher SNR).

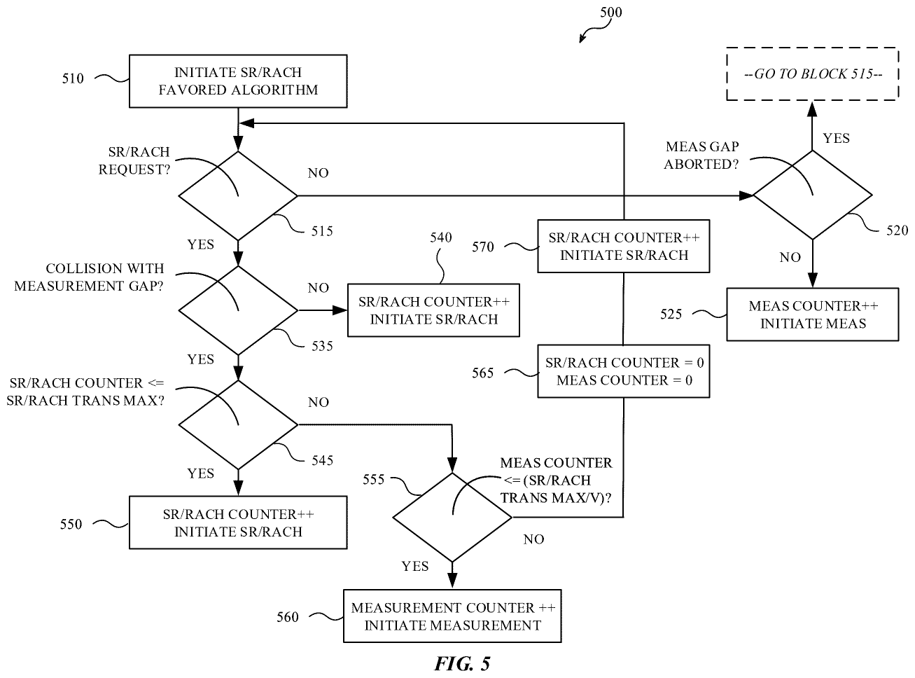

Process 400 can include performing SR/RACH procedures (block 450) and measurement procedures (block 460). For example, UE 210 can perform SR/RACH procedures and/or measurement procedures according to the SR/RACH/Meas strategy determined by UE 210 and the algorithm corresponding to the SR/RACH/Meas strategy. As mentioned above, the algorithm can include a SR/RACH favored algorithm, measurement favored algorithm, and equally favored algorithm. Additional examples and details of a SR/RACH favored algorithm, measurement favored algorithm, and equally favored algorithm are discussed below with reference to FIGS. 5, 6, and 7.

FIG. 5 is a diagram of an example of a process 500 for an SR/RACH favored algorithm for concurrency avoidance according to one or more implementations described herein. Process 500 can be implemented by UE 210. In some implementations, some or all of process 500 can be performed by one or more other systems or devices, including one or more of the devices of FIG. 2. Additionally, process 500 can include one or more fewer, additional, differently ordered and/or arranged operations than those shown in FIG. 5. In some implementations, some or all of the operations of process 500 can be performed independently, successively, simultaneously, etc., of one or more of the other operations of process 500. As such, the techniques described herein are not limited to a number, sequence, arrangement, timing, etc., of the operations or processes depicted in FIG. 5.

Process 500 can include initiating a SR/RACH favored algorithm (block 510). For example, UE 210 can initiate an SR/RACH favored algorithm in response to determining that favoring SR/RACH over measurements is a suitable strategy given a system status of UE 210. Process 500 can include determining whether there is an SR/RACH request (block 515). For example, UE 210 can receive a request, and/or detect a prompt, trigger, or conditions, for scheduling time and frequency resources for communicating with base station 222. Additionally, or alternatively, UE 210 can receive a request, and/or detect a prompt, trigger, or conditions, to perform a RACH procedure. The SR or RACH request can originate from an application or service generating UL data to be sent to base station 222.

When there is not an SR/RACH request (block 515—NO), process 500 can include determining whether a measurement gap has been aborted (block 520). For example, UE 210 can determine whether a previously scheduled and upcoming measurement gap has been aborted or is to otherwise not be observed or used for taking measurements. When there is a measurement gap has not been aborted (block 520—NO), process 500 can include increasing a measurement counter and initiating a measurement procedure (block 525). For example, when a measurement gap has not been aborted, UE 210 can use the measurement gap to perform measurement procedures. The measurement counter can indicate a number of measurement procedures that have been initiated by UE 210. The number of measurement procedures can be maintained (e.g., not reset) by UE 210 unless or until resetting the measurement counter is part of an operation of the algorithm. Additionally, or alternatively, the measurement counter can be maintained by UE 210 unless or until, for example, there is a change in a current set of conditions, until expiration of a timer or selected period of time, indefinitely, before a new algorithm is determined or implemented, or a combination thereof.

When there is a measurement gap has been aborted (block 520—YES), process 500 can include determining whether there is an SR/RACH request (block 515). When there is an SR/RACH request (block 515—YES), process 500 can include determining whether there is collision with a measurement gap (block 535). For example, UE 210 can determine whether time and/or frequency resources allocated for an SR procedure or RACH procedure conflict or overlap with one or more measurement gaps. In some implementation, any degree of overlap can be considered collision. In some implementations, at least a threshold amount of overlap is to be determined before there to be collision.

In some implementations, collision can include a scenario in which a RACH transmission or RACH occasion (RO) falls within a measurement gap. Collision can include a scenario in which a RACH transmission or RO falls within a measurement gap, and the RACH transmission or RO is prioritized over the measurement gap. In such scenarios, the RO can operate with the following configuration: a subcarrier spacing (SCS) of 15 kilohertz (kHz); an SR periodicity of 20 slots; a prohibition timer of 16 milliseconds (ms). The measurement gap periodicity can be 80 ms or 20 ms. In some implementations, collision can include a scenario in which a SR transmission or SR periodicity falls within a measurement gap. Collision can include a scenario in which a SR transmission or SR periodicity falls within a measurement gap and the SR transmission or SR periodicity is prioritized over the measurement gap. In such scenarios, the SR can operate with the following configuration: an SCS of 15 kHz; an SR periodicity of 20 slots; a prohibition timer of 16 ms. The measurement gap can operate with a periodicity of 80 ms or 20 ms.

When there is no collision with a measurement gap (block 535—NO), process 500 can include increasing an SR/RACH counter and initiating an SR/RACH procedure (block 540). For example, UE 210 can increase an SR/RACH counter and initiate an SR/RACH procedure when there is no collision with a measurement gap. The SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 565). Additionally, or alternatively, the SR/RACH counter can be maintained by UE 210 unless or until, for example, there is a change in a current set of conditions, until expiration of a timer or selected period of time, indefinitely, before a new algorithm is determined or initiated, or a combination thereof.

When there is collision with a measurement gap (block 535—YES), process 500 can include determining whether an SR/RACH counter is less than or equal to an SR/RACH transmission maximum (block 545). For example, UE 210 can compare an SR/RACH counter to a SR/RACH transmission maximum to determine whether the an SR/RACH counter is less than or equal to the SR/RACH transmission maximum. The SR/RACH transmission maximum can be configured, or specific to, the SR/RACH favored algorithm, based on UE capabilities, based on network conditions (e.g., a measured signal strength, signal to noise ratio (SNR), signal interference, etc.), based on a QoS, a corresponding logical channel, etc.

When the SR/RACH counter is less than or equal to an SR/RACH transmission maximum (block 545—YES), process 500 can include increasing an SR/RACH counter and initiating an SR/RACH procedure (block 550). For example, UE 210 can increase an SR/RACH counter and initiate an SR/RACH procedure when there is no collision with a measurement gap when an SR/RACH counter is less than or equal to an SR/RACH transmission maximum. As mentioned above, the SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 565).

When a SR/RACH counter is greater than the SR/RACH transmission maximum (block 545—NO), process 500 can include determining whether a measurement counter is less than or equal to the SR/RACH transmission maximum divided by a value (V) (block 555). For example, UE 210 can divide the SR/RACH transmission maximum based on a value (e.g., 2, 4, 6, 8, etc.) to determine a modified a SR/RACH transmission maximum. UE 210 can determine whether the measurement counter is less than or equal to the modified SR/RACH transmission maximum. In some implementations, the SR/RACH transmission maximum can be modified in other way, using another function, or additional or alternative value(s), mathematical expressions, etc.

When the measurement counter is less than or equal to the modified SR/RACH transmission maximum (block 555—YES), process 500 can include increasing a measurement counter and initiating a measurement procedure (block 560). For example, UE 210 can increase the measurement counter for measurement procedures and initiate a measurement procedure when the measurement counter is less than or equal to the modified SR/RACH transmission maximum. The number of measurement procedures can be maintained (e.g., not reset) by UE 210 unless or until resetting the measurement counter is part of an operation of the algorithm. Additionally, or alternatively, the measurement counter can be maintained by UE 210 unless or until, for example, there is a change in a current set of conditions, until expiration of a timer or selected period of time, indefinitely, before a new algorithm is determined or implemented, or a combination thereof.

When the measurement counter is greater than the modified SR/RACH transmission maximum (block 555—NO), process 500 can include resetting the SR/RACH counter to zero and the measurement counter to zero (block 565). For example, UE 210 can reset the SR/RACH and measurement counters to zero when the measurement counter is greater than the modified SR/RACH transmission maximum. The values of the SR/RACH transmission maximum, the value (V), the modified SR/RACH transmission maximum, resetting the SR/RACH and measurement counters to zero, etc., can enable process 500 to give varying degrees of priority or preference to SR/RACH procedures over measurement procedures.

Process 500 can include increasing an SR/RACH counter and initiating an SR/RACH procedure (block 570). For example, UE 210 can increase an SR/RACH counter and initiate an SR/RACH procedure when there is no collision with a measurement gap. The SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 565). Additionally, or alternatively, the SR/RACH counter can be maintained by UE 210 unless or until, for example, there is a change in a current set of conditions, until expiration of a timer or selected period of time, indefinitely, before a new algorithm is determined or initiated, or a combination thereof. Process 500 can return to determining whether there is an SR/RACH request (block 515).

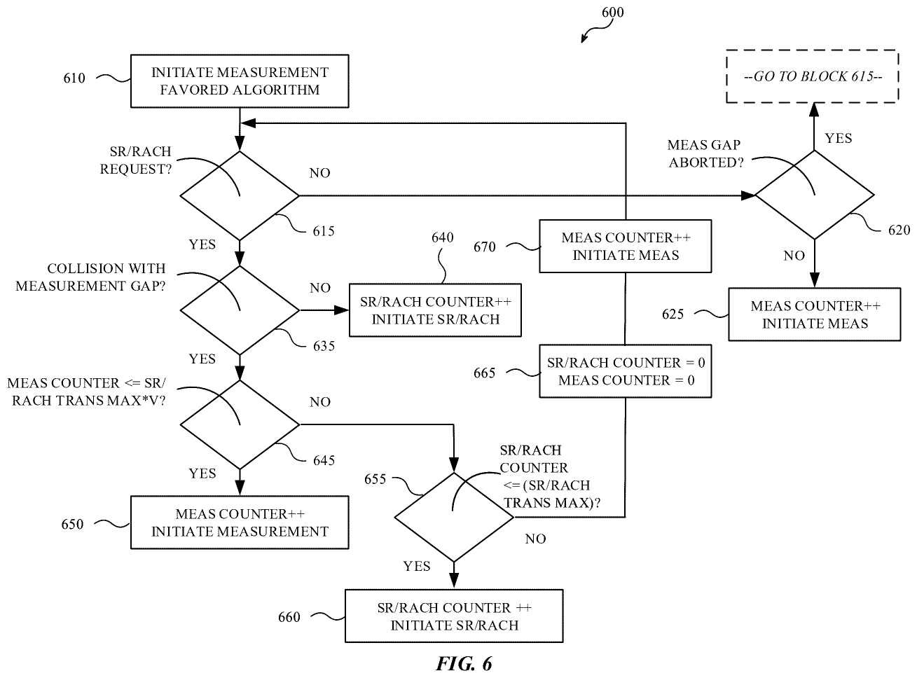

FIG. 6 is a diagram of an example of a process 600 for a measurement favored algorithm for concurrency avoidance according to one or more implementations described herein. Process 600 can be implemented by UE 210. In some implementations, some or all of process 600 can be performed by one or more other systems or devices, including one or more of the devices of FIG. 2. Additionally, process 600 can include one or more fewer, additional, differently ordered and/or arranged operations than those shown in FIG. 6. In some implementations, some or all of the operations of process 600 can be performed independently, successively, simultaneously, etc., of one or more of the other operations of process 600. As such, the techniques described herein are not limited to a number, sequence, arrangement, timing, etc., of the operations or processes depicted in FIG. 6.

Process 600 can include initiating a measurement favored algorithm (block 610). For example, UE 210 can initiate a measurement favored algorithm in response to determining that favoring measurements over SR/RACH is a suitable strategy given a system status of UE 210. Process 600 can include determining whether there is an SR/RACH request (block 615). For example, UE 210 can receive a request, and/or detect a prompt, trigger, or conditions, for scheduling time and frequency resources for communicating with base station 222. Additionally, or alternatively, UE 210 can receive a request, and/or detect a prompt, trigger, or conditions, to perform a RACH procedure. The SR or RACH request can originate from an application or service generating UL data to be sent to base station 222.

When there is not an SR/RACH request (block 615—NO), process 600 can include determining whether a measurement gap has been aborted (block 620). For example, UE 210 can determine whether a previously scheduled and upcoming measurement gap has been aborted or is to otherwise not be observed or used for taking measurements. When there is a measurement gap has not been aborted (block 620—NO), process 600 can include increasing a measurement counter and initiating a measurement procedure (block 625). For example, when a measurement gap has not been aborted, UE 210 can use the measurement gap to perform measurement procedures. The measurement counter can indicate a number of measurement procedures that have been initiated by UE 210. The number of measurement procedures can be maintained (e.g., not reset) by UE 210 unless or until resetting the measurement counter is part of an operation of the algorithm. Additionally, or alternatively, the measurement counter can be maintained by UE 210 unless or until, for example, there is a change in a current set of conditions, until expiration of a timer or selected period of time, indefinitely, before a new algorithm is determined or implemented, or a combination thereof.

When there is a measurement gap has been aborted (block 620—YES), process 600 can include determining whether there is an SR/RACH request (block 615). When there is an SR/RACH request (block 615—YES), process 600 can include determining whether there is collision with a measurement gap (block 635). For example, UE 210 can determine whether resources allocated for an SR request or procedure or RACH request or procedure conflicts, interferes, or otherwise overlaps in a time domain with one or more measurement gaps. In some implementation, any degree of overlap can be considered collision. In some implementations, at least a threshold amount of overlap is to be determined before there to be collision.

In some implementations, collision can include a scenario in which a RACH transmission or RACH occasion (RO) falls within a measurement gap. Collision can include a scenario in which a RACH transmission or RO falls within a measurement gap, and the measurement gap can be prioritized over the RACH transmission or RO. In such scenarios, the RO can operate with the following configuration: an SCS of 15 kHz; an SR periodicity of 20 slots; a prohibition timer of 16 ms. The measurement gap periodicity can be 80 ms or 20 ms. In some implementations, collision can include a scenario in which a SR transmission or SR periodicity falls within a measurement gap. Collision can include a scenario in which a SR transmission or SR periodicity falls within a measurement gap, and the measurement gap can be prioritized over the SR transmission or SR periodicity. In such scenarios, the SR can operate with the following configuration: an SCS of 15 kHz; an SR periodicity of 20 slots; a prohibition timer of 16 ms. The measurement gap can operate with a periodicity of 80 ms or 20 ms.

When there is no collision with a measurement gap (block 635—NO), process 600 can include increasing an SR/RACH counter and initiating an SR/RACH procedure (block 640). For example, UE 210 can increase an SR/RACH counter and initiate an SR/RACH procedure when there is no collision with a measurement gap. The SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 665). Additionally, or alternatively, the SR/RACH counter can be maintained by UE 210 unless or until, for example, there is a change in a current set of conditions, until expiration of a timer or selected period of time, indefinitely, before a new algorithm is determined or initiated, or a combination thereof.

When there is collision with a measurement gap (block 635—YES), process 600 can include determining whether a measurement counter is less than or equal to a modified SR/RACH transmission maximum (block 645). For example, UE 210 can multiply an SR/RACH transmission maximum based on a value (V) (e.g., 2, 4, 6, 8, etc.) to determine a modified a SR/RACH transmission maximum. UE 210 can determine whether the measurement counter is less than or equal to the modified SR/RACH transmission maximum. The SR/RACH transmission maximum can be configured, or specific to, the measurement favored algorithm, based on UE capabilities, based on network conditions (e.g., a measured signal strength, signal to noise ratio (SNR), signal interference, etc.), based on a QoS, a corresponding logical channel, etc. In some implementations, the SR/RACH transmission maximum can be modified in other way, using another function, or additional or alternative value(s), mathematical expression, etc.

When the measurement counter is less than or equal to a modified SR/RACH transmission maximum (block 645—YES), process 600 can include increasing a measurement counter and initiating a measurement procedure (block 650). For example, UE 210 can increase the measurement counter for measurement procedures and initiate a measurement procedure when the measurement counter is less than or equal to a modified SR/RACH transmission maximum. The number of measurement procedures can be maintained (e.g., not reset) by UE 210 unless or until resetting the measurement counter is part of an operation of the algorithm. Additionally, or alternatively, the measurement counter can be maintained by UE 210 unless or until, for example, there is a change in a current set of conditions, until expiration of a timer or selected period of time, indefinitely, before a new algorithm is determined or implemented, or a combination thereof.

When the measurement counter is greater than the modified SR/RACH transmission maximum (block 645—YES), process 600 can include determining whether an SR/RACH counter is less than or equal to the SR/RACH transmission maximum (block 655). For example, UE 210 can compare the SR/RACH counter to the SR/RACH transmission maximum to determine whether the an SR/RACH counter is less than or equal to the SR/RACH transmission maximum. The SR/RACH transmission maximum can be configured, or specific to, the measurement favored algorithm, based on UE capabilities, based on network conditions (e.g., a measured signal strength, signal to noise ratio (SNR), signal interference, etc.), based on a QoS, a corresponding logical channel, etc.

When the SR/RACH counter is less than or equal to the SR/RACH transmission maximum (block 655—YES), process 600 can include increasing an SR/RACH counter and initiating an SR/RACH procedure (block 660). For example, UE 210 can increase an SR/RACH counter and initiate an SR/RACH procedure when there is no collision with a measurement gap when an SR/RACH counter is less than or equal to an SR/RACH transmission maximum. As mentioned above, the SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 665).

When the SR/RACH counter is greater than the SR/RACH transmission maximum (block 655—NO), process 600 can include resetting the SR/RACH counter to zero and the measurement counter to zero (block 665). For example, UE 210 can reset the SR/RACH and measurement counters to zero when the SR/RACH counter is greater than the SR/RACH transmission maximum. The values of the SR/RACH transmission maximum, the value (V), the modified SR/RACH transmission maximum, resetting the SR/RACH and measurement counters to zero, etc., can enable process 600 to give varying degrees of priority or preference to measurement procedures over SR/RACH procedures.

Process 600 can include increasing measurement counter and initiating a measurement (block 650). For example, UE 210 can increase an SR/RACH counter and initiate an SR/RACH procedure there is no collision with a measurement gap when an SR/RACH counter is less than or equal to an SR/RACH transmission maximum. As mentioned above, the SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 665). Process 600 can return to determining whether there is an SR/RACH request (block 615).

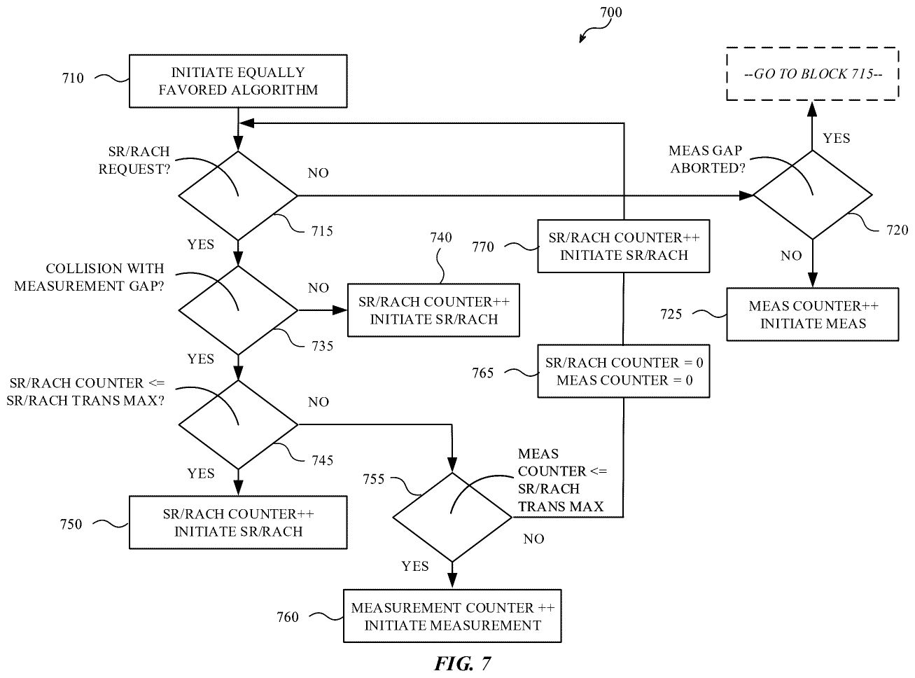

FIG. 7 is a diagram of an example of a process 700 for an equally favored algorithm for concurrency avoidance according to one or more implementations described herein. Process 700 can be implemented by UE 210. In some implementations, some or all of process 700 can be performed by one or more other systems or devices, including one or more of the devices of FIG. 2. Additionally, process 700 can include one or more fewer, additional, differently ordered and/or arranged operations than those shown in FIG. 7. In some implementations, some or all of the operations of process 700 can be performed independently, successively, simultaneously, etc., of one or more of the other operations of process 700. As such, the techniques described herein are not limited to a number, sequence, arrangement, timing, etc., of the operations or processes depicted in FIG. 7.

Process 700 can include initiating an equally favored algorithm (block 710). For example, UE 210 can initiate an equally favored algorithm in response to determining that favoring SR/RACH and measurements equally is a suitable strategy given a system status of UE 210. Process 700 can include determining whether there is an SR/RACH request (block 715). For example, UE 210 can receive a request, and/or detect a prompt, trigger, or conditions, for scheduling time and frequency resources for communicating with base station 222. Additionally, or alternatively, UE 210 can receive a request, and/or detect a prompt, trigger, or conditions, to perform a RACH procedure. The SR or RACH request can originate from an application or service generating UL data to be sent to base station 222.

When there is not an SR/RACH request (block 715—NO), process 700 can include determining whether a measurement gap has been aborted (block 720). For example, UE 210 can determine whether a previously scheduled and upcoming measurement gap has been aborted or is to otherwise not be observed or used for taking measurements. When there is a measurement gap has not been aborted (block 720—NO), process 700 can include increasing a measurement counter and initiating a measurement procedure (block 725). For example, when a measurement gap has not been aborted, UE 210 can use the measurement gap to perform measurement procedures. The measurement counter can indicate a number of measurement procedures that have been initiated by UE 210. The number of measurement procedures can be maintained (e.g., not reset) by UE 210 unless or until resetting the measurement counter is part of an operation of the algorithm. Additionally, or alternatively, the measurement counter can be maintained by UE 210 unless or until, for example, there is a change in a current set of conditions, until expiration of a timer or selected period of time, indefinitely, before a new algorithm is determined or implemented, or a combination thereof.

When there is a measurement gap has been aborted (block 720—YES), process 700 can include determining whether there is an SR/RACH request (block 715). When there is an SR/RACH request (block 715—YES), process 700 can include determining whether there is collision with a measurement gap (block 735). For example, UE 210 can determine whether time and/or frequency resources allocated for an SR procedure or RACH procedure conflict or overlap with one or more measurement gaps. In some implementation, any degree of overlap can be considered collision. In some implementations, at least a threshold amount of overlap is to be determined before there to be collision.

In some implementations, collision can include a scenario in which a RACH transmission or RACH occasion (RO) falls within a measurement gap. Collision can include a scenario in which a RACH transmission or RO falls within a measurement gap, and the measurement gap can be equally prioritized with respect to the RACH transmission or RO. In such scenarios, the RO can operate with the following configuration: an SCS of 15 kHz; an SR periodicity of 20 slots; a prohibition timer of 16 ms. The measurement gap periodicity can be 80 ms or 20 ms. In some implementations, collision can include a scenario in which a SR transmission or SR periodicity falls within a measurement gap. Collision can include a scenario in which a SR transmission or SR periodicity falls within a measurement gap, and the measurement gap can be equally prioritized with respect to the SR transmission or SR periodicity. In such scenarios, the SR can operate with the following configuration: an SCS of 15 kHz; an SR periodicity of 20 slots; a prohibition timer of 16 ms. The measurement gap can operate with a periodicity of 80 ms or 20 ms.

When there is no collision with a measurement gap (block 735—NO), process 700 can include increasing an SR/RACH counter and initiating an SR/RACH procedure (block 740). For example, UE 210 can increase an SR/RACH counter and initiate an SR/RACH procedure when there is no collision with a measurement gap. The SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 765). Additionally, or alternatively, the SR/RACH counter can be maintained by UE 210 unless or until, for example, there is a change in a current set of conditions, until expiration of a timer or selected period of time, indefinitely, before a new algorithm is determined or initiated, or a combination thereof.

When there is collision with a measurement gap (block 735—YES), process 700 can include determining whether an SR/RACH counter is less than or equal to an SR/RACH transmission maximum (block 745). For example, UE 210 can compare an SR/RACH counter to a SR/RACH transmission maximum to determine whether the an SR/RACH counter is less than or equal to the SR/RACH transmission maximum. The SR/RACH transmission maximum can be configured, or specific to, the equally favored algorithm, based on UE capabilities, based on network conditions (e.g., a measured signal strength, signal to noise ratio (SNR), signal interference, etc.), based on a QoS, a corresponding logical channel, etc.

When the SR/RACH counter is less than or equal to the SR/RACH transmission maximum (block 745—YES), process 700 can include increasing an SR/RACH counter and initiating an SR/RACH procedure (block 750). For example, UE 210 can increase an SR/RACH counter and initiate an SR/RACH procedure when there is no collision with a measurement gap when an SR/RACH counter is less than or equal to an SR/RACH transmission maximum. As mentioned above, the SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 765).

When an SR/RACH counter is greater than the SR/RACH transmission maximum (block 745—NO), process 700 can include determining whether a measurement counter is less than or equal to the SR/RACH transmission maximum (block 755). For example, UE 210 can determine whether a measurement counter is less than or equal to the SR/RACH transmission maximum when the SR/RACH counter is greater than the SR/RACH transmission maximum

When the measurement counter is less than or equal to the SR/RACH transmission maximum (block 755—YES), process 700 can include increasing a measurement counter and initiating a measurement procedure (block 760). For example, UE 210 can increase the measurement counter for measurement procedures and initiate a measurement procedure when the measurement counter is less than or equal to the SR/RACH transmission maximum. The number of measurement procedures can be maintained (e.g., not reset) by UE 210 unless or until resetting the measurement counter is part of an operation of the algorithm. Additionally, or alternatively, the measurement counter can be maintained by UE 210 unless or until, for example, there is a change in a current set of conditions, until expiration of a timer or selected period of time, indefinitely, before a new algorithm is determined or implemented, or a combination thereof.

When the measurement counter is greater than the SR/RACH transmission maximum (block 755—NO), process 700 can include resetting the SR/RACH counter to zero and the measurement counter to zero (block 765). For example, UE 210 can reset the SR/RACH and measurement counters to zero when the measurement counter is greater than the SR/RACH transmission maximum. Comparing both the SR/RACH counter (in block 745) and measurement counter (in block 755) to the SR/RACH transmission maximum (e.g., instead of a modified the SR/RACH transmission maximum) can help ensure that SR/RACH procedures and measurement procedures are given the same, or a similar, priority and preference.

Process 700 can include increasing an SR/RACH counter and initiating an SR/RACH procedure (block 770). For example, UE 210 can increase an SR/RACH counter and initiate an SR/RACH procedure when there is no collision with a measurement gap. The SR/RACH counter can indicate a number of SR/RACH procedures that have been initiated by UE 210. The number of SR/RACH procedures can be maintained (e.g., not reset) by UE 210 unless or until resetting the measurement counter is part of an operation of the algorithm (see, e.g., block 765). Additionally, or alternatively, the SR/RACH counter can be maintained by UE 210 unless or until, for example, there is a change in a current set of conditions, until expiration of a timer or selected period of time, indefinitely, before a new algorithm is determined or initiated, or a combination thereof. Process 700 can return to determining whether there is an SR/RACH request (block 715).

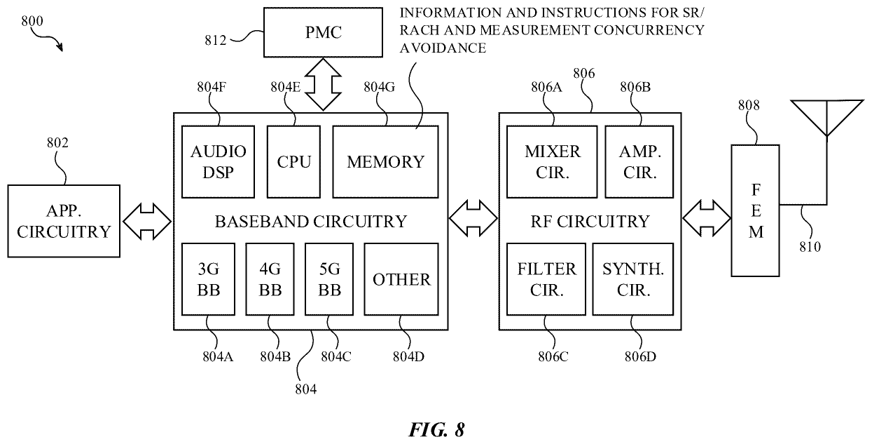

FIG. 8 is a diagram of an example of components of a device according to one or more implementations described herein. In some implementations, the device 800 can include application circuitry 802, baseband circuitry 804, RF circuitry 806, front-end module (FEM) circuitry 808, one or more antennas 810, and power management circuitry (PMC) 812 coupled together at least as shown. The components of the illustrated device 800 can be included in a UE or a RAN node. In some implementations, the device 800 can include fewer elements (e.g., a RAN node may not utilize application circuitry 802, and instead include a processor/controller to process IP data received from a CN or an Evolved Packet Core (EPC)). In some implementations, the device 800 can include additional elements such as, for example, memory/storage, display, camera, sensor (including one or more temperature sensors, such as a single temperature sensor, a plurality of temperature sensors at different locations in device 800, etc.), or input/output (I/O) interface. In other implementations, the components described below can be included in more than one device (e.g., said circuitries can be separately included in more than one device for Cloud-RAN (C-RAN) implementations).

The application circuitry 802 can include one or more application processors. For example, the application circuitry 802 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 800. In some implementations, processors of application circuitry 802 can process IP data packets received from an EPC.

The baseband circuitry 804 can include circuitry such as, but not limited to, one or more single-core or multi-core processors. The baseband circuitry 804 can include one or more baseband processors or control logic to process baseband signals received from a receive signal path of the RF circuitry 806 and to generate baseband signals for a transmit signal path of the RF circuitry 806. Baseband circuitry 804 can interface with the application circuitry 802 for generation and processing of the baseband signals and for controlling operations of the RF circuitry 806. For example, in some implementations, the baseband circuitry 804 can include a 3G baseband processor 804A, a 4G baseband processor 804B, a 5G baseband processor 804C, or other baseband processor(s) 804D for other existing generations, generations in development or to be developed in the future (e.g., 5G, 6G, etc.). The baseband circuitry 804 (e.g., one or more of baseband processors 804A-D) can handle various radio control functions that enable communication with one or more radio networks via the RF circuitry 806. In other implementations, some or all of the functionality of baseband processors 804A-D can be included in modules stored in the memory 804G and executed via a Central Processing Unit (CPU) 804E. The radio control functions can include, but are not limited to, signal modulation/demodulation, encoding/decoding, radio frequency shifting, etc. In some implementations, modulation/demodulation circuitry of the baseband circuitry 804 can include Fast-Fourier Transform (FFT), precoding, or constellation mapping/de-mapping functionality. In some implementations, encoding/decoding circuitry of the baseband circuitry 804 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 804G can receive and/or store information and instructions for avoiding concurrency of SR/RACH and measurement gaps based on system deterministic behavior. A system and decision engine can balance and adapt SR/RACH and measurement gaps. This can prioritizing SR/RACH in some scenarios and measurement gaps in other scenarios. Algorithms are provided for how, and to what extent, SR/RACH is to be favored over measurement gaps, and how, and to what extent, measurement gaps are to be favored over SR/RACH. The system and decision engine can also provide for balancing (or favoring equally) SR/RACH and measurement gaps. These and many other features and examples are described herein.

In some implementations, the baseband circuitry 804 can include one or more audio digital signal processor(s) (DSP) 804F. The audio DSPs 804F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 804 and the application circuitry 802 can be implemented together such as, for example, on a system on a chip (SOC).

In some implementations, the baseband circuitry 804 can provide for communication compatible with one or more radio technologies. For example, in some implementations, the baseband circuitry 804 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 804 is configured to support radio communications of more than one wireless protocol can be referred to as multi-mode baseband circuitry.

RF circuitry 806 can enable communication with wireless networks using modulated electromagnetic radiation through a non-solid medium. In various implementations, the RF circuitry 806 can include switches, filters, amplifiers, etc. to facilitate the communication with the wireless network. RF circuitry 806 can include a receive signal path which can include circuitry to down-convert RF signals received from the FEM circuitry 808 and provide baseband signals to the baseband circuitry 804. RF circuitry 806 can also include a transmit signal path which can include circuitry to up-convert baseband signals provided by the baseband circuitry 804 and provide RF output signals to the FEM circuitry 808 for transmission.

In some implementations, the receive signal path of the RF circuitry 806 can include mixer circuitry 806A, amplifier circuitry 806B and filter circuitry 806C. In some implementations, the transmit signal path of the RF circuitry 806 can include filter circuitry 806C and mixer circuitry 806A. RF circuitry 806 can also include synthesizer circuitry 806D for synthesizing a frequency for use by the mixer circuitry 806A of the receive signal path and the transmit signal path. In some implementations, the mixer circuitry 806A of the receive signal path can be configured to down-convert RF signals received from the FEM circuitry 808 based on the synthesized frequency provided by synthesizer circuitry 806D. The amplifier circuitry 806B can be configured to amplify the down-converted signals and the filter circuitry 806C can be a low-pass filter (LPF) or band-pass filter (BPF) configured to remove unwanted signals from the down-converted signals to generate output baseband signals. Output baseband signals can be provided to the baseband circuitry9404 for further processing. In some implementations, the output baseband signals can be zero-frequency baseband signals, although this is not a requirement. In some implementations, mixer circuitry 806A of the receive signal path can comprise passive mixers, although the scope of the implementations is not limited in this respect.

In some implementations, the mixer circuitry 806A of the transmit signal path can be configured to up-convert input baseband signals based on the synthesized frequency provided by the synthesizer circuitry 806D to generate RF output signals for the FEM circuitry 808. The baseband signals can be provided by the baseband circuitry 804 and can be filtered by filter circuitry 806C. In some implementations, the mixer circuitry 06A of the receive signal path and the mixer circuitry 1906A of the transmit signal path can include two or more mixers and can be arranged for quadrature down conversion and up conversion, respectively. In some implementations, the mixer circuitry 806A of the receive signal path and the mixer circuitry 806A of the transmit signal path can include two or more mixers and can be arranged for image rejection (e.g., Hartley image rejection). In some implementations, the mixer circuitry 06A of the receive signal path and the mixer circuitry906A can be arranged for direct down conversion and direct up conversion, respectively. In some implementations, the mixer circuitry 8069 of the receive signal path and the mixer circuitry 806A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 806 can include analog-to-digital converter (ADC) and digital-to-analog converter (DAC) circuitry and the baseband circuitry 804 can include a digital baseband interface to communicate with the RF circuitry 806.

In some dual-mode implementations, a separate radio IC circuitry can be provided for processing signals for each spectrum, although the scope of the implementations is not limited in this respect. In some implementations, the synthesizer circuitry 806D can be a fractional-N synthesizer or a fractional N/N+1 synthesizer, although the scope of the implementations is not limited in this respect as other types of frequency synthesizers can be suitable. For example, synthesizer circuitry 806D can be a delta-sigma synthesizer, a frequency multiplier, or a synthesizer comprising a phase-locked loop with a frequency divider.

The synthesizer circuitry 806D can be configured to synthesize an output frequency for use by the mixer circuitry 806A of the RF circuitry 806 based on a frequency input and a divider control input. In some implementations, the synthesizer circuitry 806D can be a fractional N/N+1 synthesizer.

In some implementations, frequency input can be provided by a voltage-controlled oscillator (VCO), although that is not a requirement. Divider control input can be provided by either the baseband circuitry 804 or the applications circuitry 802 depending on the desired output frequency. In some implementations, a divider control input (e.g., N) can be determined from a look-up table based on a channel indicated by the applications circuitry 802.

Synthesizer circuitry 806D of the RF circuitry 806 can include a divider, a delay-locked loop (DLL), a multiplexer and a phase accumulator. In some implementations, the divider can be a dual modulus divider (DMD), and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 806D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 806 can include an IQ/polar converter.

FEM circuitry 808 can include a receive signal path which can include circuitry configured to operate on RF signals received from one or more antennas 810, amplify the received signals and provide the amplified versions of the received signals to the RF circuitry 806 for further processing. FEM circuitry 808 can also include a transmit signal path which can include circuitry configured to amplify signals for transmission provided by the RF circuitry 806 for transmission by one or more of the one or more antennas 810. In various implementations, the amplification through the transmit or receive signal paths can be done solely in the RF circuitry 806, solely in the FEM circuitry 808, or in both the RF circuitry 806 and the FEM circuitry 808.

In some implementations, the FEM circuitry 808 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 806). The transmit signal path of the FEM circuitry 808 can include a power amplifier (PA) to amplify input RF signals (e.g., provided by RF circuitry 806), and one or more filters to generate RF signals for subsequent transmission (e.g., by one or more of the one or more antennas 810).

In some implementations, the PMC 812 can manage power provided to the baseband circuitry 804. In particular, the PMC 812 can control power-source selection, voltage scaling, battery charging, or DC-to-DC conversion. The PMC 812 can often be included when the device 800 is capable of being powered by a battery, for example, when the device is included in a UE. The PMC 812 can increase the power conversion efficiency while providing desirable implementation size and heat dissipation characteristics.

While FIG. 8 shows the PMC 812 coupled only with the baseband circuitry 804. However, in other implementations, the PMC 812 can be additionally or alternatively coupled with, and perform similar power management operations for, other components such as, but not limited to, application circuitry 802, RF circuitry 806, or FEM circuitry 808.

In some implementations, the PMC 812 can control, or otherwise be part of, various power saving mechanisms of the device 800. For example, if the device 800 is in an RRC_Connected state, where it is still connected to the RAN node as it expects to receive traffic shortly, then it can enter a state known as Discontinuous Reception Mode (DRX) after a period of inactivity. During this state, the device 800 can power down for brief intervals of time and thus save power.

If there is no data traffic activity for an extended period of time, then the device 800 can transition off to an RRC_Idle state, where it disconnects from the network and does not perform operations such as channel quality feedback, handover, etc. The device 800 goes into a very low power state and it performs paging where again it periodically wakes up to listen to the network and then powers down again. The device 800 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 802 and processors of the baseband circuitry 804 can be used to execute elements of one or more instances of a protocol stack. For example, processors of the baseband circuitry 804, alone or in combination, can be used execute Layer 3, Layer 2, or Layer 1 functionality, while processors of the baseband circuitry 804 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

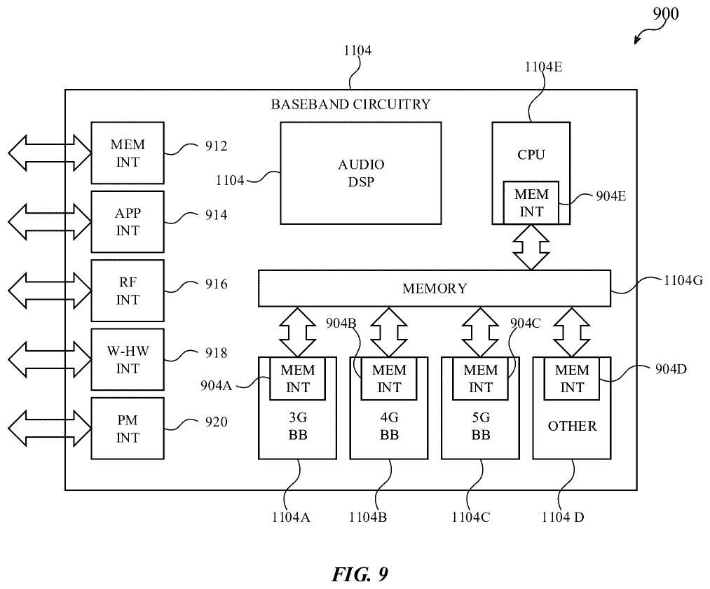

FIG. 9 is a diagram of example interfaces 900 of baseband circuitry according to one or more implementations described herein. As discussed above, the baseband circuitry 804 of FIG. 8 can comprise processors 804A, 804B, 804C, 804D, and 804E and a memory 804G utilized by said processors. Each of the processors 804A, 804B, 804C, 804D, and 804E can include a memory interface, 904A, 904B, 904C, 904D, and 904E, respectively, to send/receive data to/from the memory 804G.

In some implementations, memory 804G can receive, store, and/or provide information and instructions for avoiding concurrency of SR/RACH and measurement gaps based on system deterministic behavior. A system and decision engine can balance and adapt SR/RACH and measurement gaps. This can prioritizing SR/RACH in some scenarios and measurement gaps in other scenarios. Algorithms are provided for how, and to what extent, SR/RACH is to be favored over measurement gaps, and how, and to what extent, measurement gaps are to be favored over SR/RACH. The system and decision engine can also provide for balancing (or favoring equally) SR/RACH and measurement gaps. These and many other features and examples are described herein.

The baseband circuitry 804 can further include one or more interfaces to communicatively couple to other circuitries/devices, such as a memory interface 912 (e.g., an interface to send/receive data to/from memory external to the baseband circuitry 804), an application circuitry interface 1114 (e.g., an interface to send/receive data to/from the application circuitry 802 of FIG. 8), an RF circuitry interface 1116 (e.g., an interface to send/receive data to/from RF circuitry 806 of FIG. 8), a wireless hardware connectivity interface 918 (e.g., an interface to send/receive data to/from Near Field Communication (NFC) components, Bluetooth® components (e.g., Bluetooth® Low Energy), Wi-Fi® components, and other communication components), and a power management interface 920 (e.g., an interface to send/receive power or control signals to/from the PMC 812).

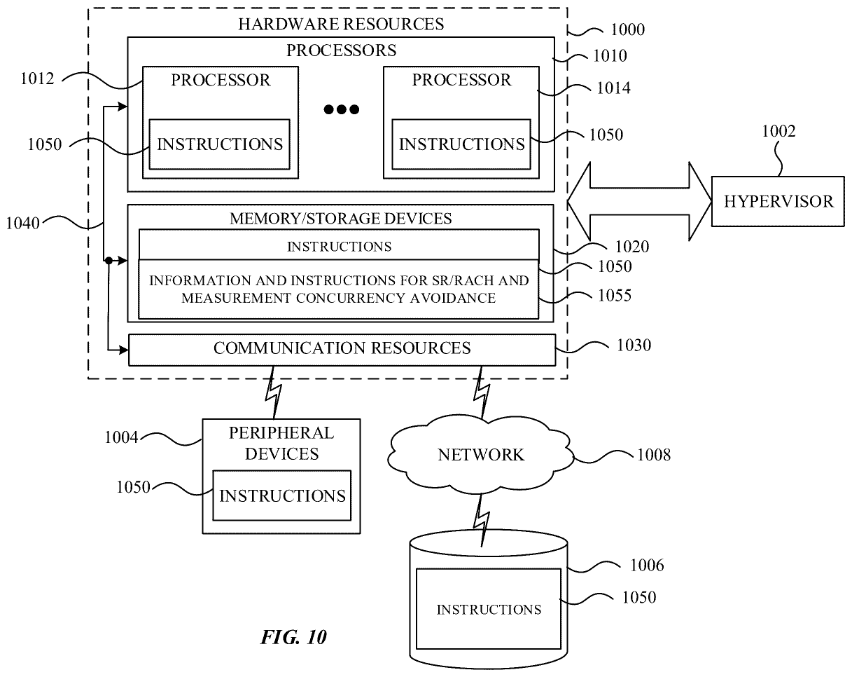

FIG. 10 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 10 shows a diagrammatic representation of hardware resources 1000 including one or more processors (or processor cores) 1010, one or more memory/storage devices 1010, and one or more communication resources 1030, each of which can be communicatively coupled via a bus 1040. For implementations where node virtualization (e.g., NFV) is utilized, a hypervisor can be executed to provide an execution environment for one or more network slices/sub-slices to utilize the hardware resources 1000. The hardware resources 1000 can interact with the hypervisor 1002. For example, the hypervisor 1002 can schedule or otherwise manage the hardware resource 1000.

The processors 1010 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) can include, for example, a processor 1012 and a processor 1014.

The memory/storage devices 1010 can include main memory, disk storage, or any suitable combination thereof. The memory/storage devices 1010 can include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1010 receive and/or store information and instructions 1055 for avoiding concurrency of SR/RACH and measurement gaps based on system deterministic behavior. A system and decision engine can balance and adapt SR/RACH and measurement gaps. This can prioritizing SR/RACH in some scenarios and measurement gaps in other scenarios. Algorithms are provided for how, and to what extent, SR/RACH is to be favored over measurement gaps, and how, and to what extent, measurement gaps are to be favored over SR/RACH. The system and decision engine can also provide for balancing (or favoring equally) SR/RACH and measurement gaps. These and many other features and examples are described herein.

The communication resources 1030 can include interconnection or network interface components or other suitable devices to communicate with one or more peripheral devices 1004 or one or more databases 1006 via a network 1008. For example, the communication resources 1030 can include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1050 can comprise software, a program, an application, an applet, an app, or other executable code for causing at least any of the processors 1010 to perform any one or more of the methodologies discussed herein. The instructions 1050 can reside, completely or partially, within at least one of the processors 1010 (e.g., within the processor's cache memory), the memory/storage devices 1010, or any suitable combination thereof. Furthermore, any portion of the instructions 1050 can be transferred to the hardware resources 1000 from any combination of the peripheral devices 1004 or the databases 1006. Accordingly, the memory of processors 1010, the memory/storage devices 1010, the peripheral devices 1004, and the databases 1006 are examples of computer-readable and machine-readable media.

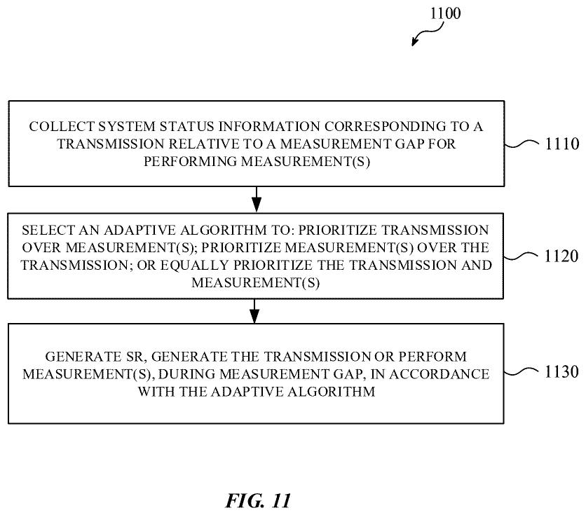

FIG. 11 is a diagram of an example process for SR/RACH and measurement concurrency avoidance according to one or more implementations described herein. Process 1100 can be implemented by UE 210 or baseband circuitry 900. In some implementations, some or all of process 1100 can be performed by one or more other systems or devices, including one or more of the devices of FIG. 2. Additionally, process 1100 can include one or more fewer, additional, differently ordered and/or arranged operations than those shown in FIG. 11. In some implementations, some or all of the operations of process 1100 can be performed independently, successively, simultaneously, etc., of one or more of the other operations of process 1100. As such, the techniques described herein are not limited to a number, sequence, arrangement, timing, etc., of the operations or processes depicted in FIG. 11.

Process 1100 can include collecting system status information corresponding to a transmission relative to a measurement gap for performing measurements (block 1110). The transmission can overlap with the measurement gap in the time domain. Process 1100 can include selecting, based on the system status information, an adaptive algorithm configured to: prioritize the transmission over the measurements; prioritize the measurements over the transmission; or equally prioritize the transmission relative to the measurements (block 1120). The transmission can include a transmission. Process 1100 can include generating the transmission or perform the measurements, during the measurement gap, in accordance with the algorithm (block 1130).

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which can also include one or more of the examples described herein, a user equipment (UE) can comprise: a memory; and one or more processors configured to, when executing instructions stored in the memory, cause the UE to: collect system status information associated with a transmission relative to a measurement gap for performing measurements, wherein the transmission at least partially overlaps with the measurement gap in the time domain; select, based on the system status information, an adaptive algorithm configured to: prioritize the transmission over the measurements; prioritize the measurements over the transmission; or equally prioritize the transmission relative to the measurements; and generate the transmission or perform a measurement, during the measurement gap, in accordance with the adaptive algorithm.

In example 2, which can also include one or more of the examples described herein, the transmission comprises: a scheduling request (SR), or a random access channel (RACH) request.

In example 3, which can also include one or more of the examples described herein, the system status information comprises: a traffic type, a traffic quantity, a quality of service (QoS), a measured mobility of UE, a level of power consumption of UE, a reference signal received power (RSRP), currently allocated time and frequency resources, a signal-to-noise ratio (SNR), a signal radio bearer (SRB) measurement report, the transmission corresponding to UE operating in a low latency mode, a number or frequency of hybrid automatic repeat-request (HARQ) transmissions or retransmissions, a power headroom report, a network initiated RACH, a timing advance (TA), or a combination thereof.

In example 4, which can also include one or more of the examples described herein, the adaptive algorithm is configured to prioritize the transmission over the measurement gap when the system status information includes a traffic type corresponding to low latency requirements and high throughput requirements.

In example 5, which can also include one or more of the examples described herein, the adaptive algorithm is configured to prioritize the measurement gap over the transmission when the system status information includes high UE mobility or a high SNR.

In example 6, which can also include one or more of the examples described herein, the adaptive algorithm is configured to equally prioritize the transmission relative to the measurements when the system status information includes: a traffic type with low latency and high throughput requirements, and high UE mobility or a high SNR.

In example 7, which can also include one or more of the examples described herein, the adaptive algorithm is configured to always generate the transmission when the transmission does not overlap with the measurement gap.

In example 8, which can also include one or more of the examples described herein, the adaptive algorithm is configured to always perform the measurements during the measurement gap when the transmission does not overlap with the measurement gap.

In example 9, which can also include one or more of the examples described herein, when the adaptive algorithm is configured to prioritize the transmission over the measurements, the transmission is generated when: the transmission overlaps with the measurement gap, and a transmission counter is less than or equal to a transmission maximum.

In example 10, which can also include one or more of the examples described herein, when the adaptive algorithm is configured to prioritize the measurements over the transmission, the measurements are performed when: the transmission overlaps with the measurement gap, and a measurement counter is less than or equal to a modified transmission maximum.

In example 11, which can also include one or more of the examples described herein, the measurement counter is increased by 1 when the measurements are performed.

In example 12, which can also include one or more of the examples described herein, when: the adaptive algorithm is configured to prioritize the transmission over the measurements, the transmission overlaps with the measurement gap, and a transmission counter is less than or equal to a transmission maximum, the transmission is generated; and the transmission counter is increased by 1.

In example 13, which can also include one or more of the examples described herein, when: the adaptive algorithm is configured to prioritize the transmission over the measurements, the transmission overlaps with the measurement gap, a transmission counter is greater than a transmission maximum, and a measurement counter is less than or equal to a modified transmission maximum, the measurements are performed during the measurement gap, and the measurement counter is increased by 1.

In example 14, which can also include one or more of the examples described herein, when the measurement counter is greater than the modified transmission maximum, the transmission counter is set to zero, the measurements counter is set to zero, the transmission is generated; and the transmission counter is increased by 1.

In example 15, which can also include one or more of the examples described herein, when: the adaptive algorithm is configured to prioritize the measurements over the transmission, the transmission overlaps with the measurement gap, a measurement counter is greater than a modified transmission maximum, a transmission counter less than or equal to a transmission maximum, and the transmission is generated; and the transmission counter is increased by 1.

In example 16, which can also include one or more of the examples described herein, when the transmission counter is greater than the transmission maximum, the transmission counter is set to zero, the measurements counter is set to zero, the measurements are performed during the measurement gap, and the measurement counter is increased by 1.

In example 17, which can also include one or more of the examples described herein, when: the adaptive algorithm is configured to equally prioritize the transmission relative to the measurements, the transmission overlaps with the measurement gap, a transmission counter is greater than a transmission maximum, and a measurement counter is less than or equal to the transmission maximum, the measurements are performed during the measurement gap, and the measurement counter is increased by 1.

In example 18, which can also include one or more of the examples described herein, a method, performed by a user equipment (UE), can comprise: collecting system status information corresponding to a transmission relative to a measurement gap for performing measurements, wherein the transmission overlaps with the measurement gap in the time domain; selecting, based on the system status information, an adaptive algorithm configured to: prioritize the transmission over the measurements; prioritize the measurements over the transmission; or equally prioritize the transmission relative to the measurements; and generating the transmission or perform a measurement, during the measurement gap, in accordance with the adaptive algorithm.

In example 19, which can also include one or more of the examples described herein, baseband circuitry can comprise: a memory; and one or more processors configured to, when executing instructions stored in the memory, cause the baseband circuitry to: collect system status information corresponding to a transmission relative to a measurement gap for performing measurements, wherein the transmission overlaps with the measurement gap in the time domain; select, based on the system status information, an adaptive algorithm configured to: prioritize the transmission over the measurements; prioritize the measurements over the transmission; or equally prioritize the transmission relative to the measurements; and generate the transmission or perform a measurement, during the measurement gap, in accordance with the adaptive algorithm.

In example 20, which can also include one or more of the examples described herein, the transmission counter is increased by 1 when the transmission is generated.

In example 21, which can also include one or more of the examples described herein, a computer-readable medium can comprise one or more instructions that when expected by one or more processors can cause the one or more processors to: collect system status information associated with a transmission relative to a measurement gap for performing measurements, wherein the transmission at least partially overlaps with the measurement gap in the time domain; select, based on the system status information, an adaptive algorithm configured to: prioritize the transmission over the measurements; prioritize the measurements over the transmission; or equally prioritize the transmission relative to the measurements; and generate the transmission or perform a measurement, during the measurement gap, in accordance with the adaptive algorithm.

In example 22, which can also include one or more of the examples described herein, a computer-readable medium can comprise one or more instructions that when expected by one or more processors can cause the one or more processors to: collect system status information corresponding to a transmission relative to a measurement gap for performing measurements, wherein the transmission overlaps with the measurement gap in the time domain; select, based on the system status information, an adaptive algorithm configured to: prioritize the transmission over the measurements; prioritize the measurements over the transmission; or equally prioritize the transmission relative to the measurements; and generate the transmission or perform a measurement, during the measurement gap, in accordance with the adaptive algorithm.

In example 20, which can also include one or more of the examples described herein, the transmission counter is increased by 1 when the transmission is generated.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature can have been disclosed with respect to only one of several implementations, such feature can be combined with one or more other features of the other implementations as can be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context can indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A user equipment (UE), comprising:
a memory; and
one or more processors configured to, when executing instructions stored in the memory, cause the UE to:
collect system status information associated with a transmission relative to a measurement gap for performing measurements, wherein the transmission at least partially overlaps with the measurement gap in a time domain;
select, based on the system status information, an adaptive algorithm configured to:
prioritize the transmission over the measurements;
prioritize the measurements over the transmission; or
equally prioritize the transmission relative to the measurements; and
generate the transmission or perform a measurement, during the measurement gap, in accordance with the adaptive algorithm.

2. The UE of claim 1, wherein the transmission comprises:
a scheduling request (SR), or
a random access channel (RACH) request.

3. The UE of claim 1, wherein the system status information comprises:
a traffic type,
a traffic quantity,
a quality of service (QoS),
a measured mobility of the UE,
a level of power consumption of the UE,
a reference signal received power (RSRP),
currently allocated time and frequency resources,
a signal-to-noise ratio (SNR),
a signal radio bearer (SRB) measurement report,
the transmission corresponding to UE operating in a low latency mode,
a number or frequency of hybrid automatic repeat-request (HARQ) transmissions or retransmissions,
a power headroom report,
a network initiated RACH,
a timing advance (TA), or
a combination thereof.

4. The UE of claim 1, wherein the adaptive algorithm is configured to prioritize the transmission over the measurement gap when the system status information includes a traffic type corresponding to low latency requirements and high throughput requirements.

5. The UE of claim 1, wherein the adaptive algorithm is configured to prioritize the measurement gap over the transmission when the system status information includes high UE mobility or a high SNR.

6. The UE of claim 1, wherein the adaptive algorithm is configured to equally prioritize the transmission relative to the measurements when the system status information includes:
a traffic type with low latency and high throughput requirements, and
high UE mobility or a high SNR.

7. The UE of claim 1, wherein the adaptive algorithm is configured to always generate the transmission when the transmission does not overlap with the measurement gap.

8. The UE of claim 1, wherein the adaptive algorithm is configured to always perform the measurements during the measurement gap when the transmission does not overlap with the measurement gap.

9. The UE of claim 1, wherein, when the adaptive algorithm is configured to prioritize the transmission over the measurements, the transmission is generated when:
the transmission overlaps with the measurement gap, and
a transmission counter is less than or equal to a transmission maximum.

10. The UE of claim 9, wherein the transmission counter is increased by 1 when the transmission is generated.

11. The UE of claim 1, wherein, when the adaptive algorithm is configured to prioritize the measurements over the transmission, the measurements are performed when:
the transmission overlaps with the measurement gap, and
a measurement counter is less than or equal to a modified transmission maximum.

12. The UE of claim 1, wherein a measurement counter is increased by 1 when the measurements are performed.

13. The UE of claim 1, wherein, when:
the adaptive algorithm is configured to prioritize the transmission over the measurements,
the transmission overlaps with the measurement gap, and
a transmission counter is less than or equal to a transmission maximum,
the transmission is generated; and
the transmission counter is increased by 1.

14. The UE of claim 1, wherein, when:
the adaptive algorithm is configured to prioritize the transmission over the measurements,
the transmission overlaps with the measurement gap,
a transmission counter is greater than a transmission maximum, and
a measurement counter is less than or equal to a modified transmission maximum,
the measurements are performed during the measurement gap, and
the measurement counter is increased by 1.

15. The UE of claim 14, wherein, when the measurement counter is greater than the modified transmission maximum,
the transmission counter is set to zero,
the measurements counter is set to zero,
the transmission is generated; and
the transmission counter is increased by 1.

16. The UE of claim 1, wherein, when:
the adaptive algorithm is configured to prioritize the measurements over the transmission,
the transmission overlaps with the measurement gap,
a measurement counter is greater than a modified transmission maximum,
a transmission counter less than or equal to a transmission maximum, and
the transmission is generated; and
the transmission counter is increased by 1.

17. The UE of claim 16, wherein, when the transmission counter is greater than the transmission maximum,
the transmission counter is set to zero,
the measurements counter is set to zero,
the measurements are performed during the measurement gap, and
the measurement counter is increased by 1.

18. The UE of claim 1, wherein, when:
the adaptive algorithm is configured to equally prioritize the transmission relative to the measurements,
the transmission overlaps with the measurement gap,
a transmission counter is greater than a transmission maximum, and
a measurement counter is less than or equal to a transmission maximum,
the measurements are performed during the measurement gap, and
the measurement counter is increased by 1.

19. A method, performed by a user equipment (UE), comprising:
collecting system status information corresponding to a transmission relative to a measurement gap for performing measurements, wherein the transmission overlaps with the measurement gap in a time domain;
selecting, based on the system status information, an adaptive algorithm configured to:
prioritize the transmission over the measurements;
prioritize the measurements over the transmission; or
equally prioritize the transmission relative to the measurements; and
generating the transmission or perform a measurement, during the measurement gap, in accordance with the adaptive algorithm.

20. Baseband circuitry, comprising:
a memory; and
one or more processors configured to, when executing instructions stored in the memory, cause the baseband circuitry to:
collect system status information corresponding to a transmission relative to a measurement gap for performing measurements, wherein the transmission overlaps with the measurement gap in a time domain;
select, based on the system status information, an adaptive algorithm configured to:
prioritize the transmission over the measurements;
prioritize the measurements over the transmission; or
equally prioritize the transmission relative to the measurements; and
generate the transmission or perform a measurement, during the measurement gap, in accordance with the adaptive algorithm.
